(19) United States
(12) Patent Application Publication
(10) Pub. No.: US 2010/0145238 A1
(43) Pub. Date: Jun. 10, 2010

(54) ORTHESIS

(76) Inventors: Adrianus Hubertus Arno Stienen, Chicago, IL (US); Edsko Evert Geert Hekman, Enschede (NL); Herman Van Der Kooij, Utrecht (NL)

Correspondence Address: THE NATH LAW GROUP, 112 South West Street, Alexandria, VA, 22314, US

(21) Appl. No.: 12/445,425

(22) PCT Filed: Oct. 5, 2007
(86) PCT No.: PCT/EP2007/008712

§ 371 Date: Feb. 15, 2010

(30) Foreign Application Priority Data
Oct. 12, 2006 (EP) 06021378.2

(51) Int. Cl. A61H 1/02

(52) U.S. Cl. 601/33

(57) ABSTRACT

The invention relates to an orthesis for controlling the angle of a limb relative to a second body part to which the limb is connected via a joint such as a hip, elbow or shoulder, which orthesis comprises:—a first arm rotatably, around a rotation point, connected to the second body part;—a second arm fixedly arranged to the lim; and—guide means for providing at least a two dimensional free translation of the second arm relative to the first arm, while maintaining both arms parallel.

The invention relates to an orthesis for controlling the angle of a limb relative to a second body part to which the limb is connected via a joint, such as a hip, elbow or shoulder.

Such an orthesis can be used for training the muscles around a joint. Especially for people who have lost control of a limb as a result of a cerebral vascular accident (CVA) it is necessary that when recovering from a CVA the resistance or assistance to muscle activity is varied according to specific training programs such that the person can learn to use the muscles again properly. So a work out device as commonly found in health clubs is not suitable for such a recovery.

Devices are known which can provide assistive or resistive moments to limbs around a joint. However these devices all have in common that they should be aligned with the rotation axis of the joint which is to be trained. Without such an alignment, the device will not enable free movement of the joint. Such an alignment takes generally considerable time, which reduces the effective time for training the joint.

WO-A-92 13504 describes a system for training of limbs or controlling movement thereof. This system comprises a rod system including three arms which are held parallel and which have all a point of rotation in common with a fourth arm. The three arms are kept parallel such that rotation of a first arm will result in the rotation of the second and third arm over the same angle. However this rod system does not enable a two dimensional free translation of two parallel arms while maintaining both arms parallel. Due to the rod system disclosed in this document, being a combination of two parallelogram rod systems having two rods both in common. This provides a single dimensional free translation while keeping two arms parallel but not a two dimensional free translation.

Furthermore, such alignment is intrinsically inaccurate, since none of the joints of the human body allows rotation about one stationary axis or set of stationary axes.

It is therefor an object of the invention to provide an orthesis in which the above mentioned disadvantages are reduced or even alleviated.

This object is achieved by an orthesis according to the invention, which orthesis comprises:
a first arm rotatably, around a rotation point, connected to the second body part;
a second arm fixedly arranged to the limb; and
guide means for providing at least a two dimensional free translation of the second arm relative to the first arm, while maintaining both aims parallel. With parallel is mean being in the same rotational disposition towards each other.

By providing guide means, which provide at least a two dimensional free translation of the second arm, it is no longer necessary to align the orthesis with the rotation axis of the joint of the limb. When moving the limb, the orthesis will freely move in the two dimensions to compensate for the misalignment between the orthesis and the joint.

In a preferred embodiment of the orthesis according to the invention, the guide means comprise a rod system comprising:
a first rod parallel to both arms
a first pair of parallel equal length rods, each rotatably connecting the first rod with the first arm; and
a second pair of parallel equal length rods, each rotatably connecting the first rod with the second arm.

Such a rod system provides a robust embodiment of the guide means and provides the two dimensional free translation of the second arm, while maintaining the first arm and the second arm parallel. By maintaining the first arm and the second arm parallel it is possible to influence the rotation of the joint, while the orthesis and the joint are misaligned.

In another preferred embodiment of the orthesis according to the invention, the guide means comprise a rod system comprising a connecting rod, which is with one end slidably arranged to the first arm and with the other end slidably arranged to the second aim, wherein the two sliding directions are perpendicular to each other. This rod system with a connecting rod slidably arranged is an alternative for the previous mentioned rod system. It provides the necessary two dimensional free translation, while the first arm and second aim are kept parallel.

In another embodiment of the orthesis according to the invention the orthesis comprises control means from controlling the rotation of the first arm. The control means comprise for example friction means for providing friction to the rotation point. While the first arm and second arm are kept parallel as a result of the guide means, it is possible to impose some resistance to the joint enabling the person to train the muscles around this joint.

In yet another embodiment of the orthesis according to the invention, the control means comprise a motor for propelling the first arm. In cases, where the person is not able to move the joint himself, it is possible to assist the person in training by propelling the first arm. By measuring the angle between the arms it is possible to determine a path of movement and subsequently controlling the motor accordingly.

Preferably the rotation point of the first arm of the orthesis comprise a strap for attachment to a body part. Furthermore, it is desirable when the second arm comprise a strap for attachment to the limb. This provides for an orthesis, which can quickly be attached to the limb to be trained. As alignment is not necessary anymore, a substantial amount of time is saved and available for training.

These and other features and advantages of the invention will be elucidated in conjunction with the accompanying drawings.

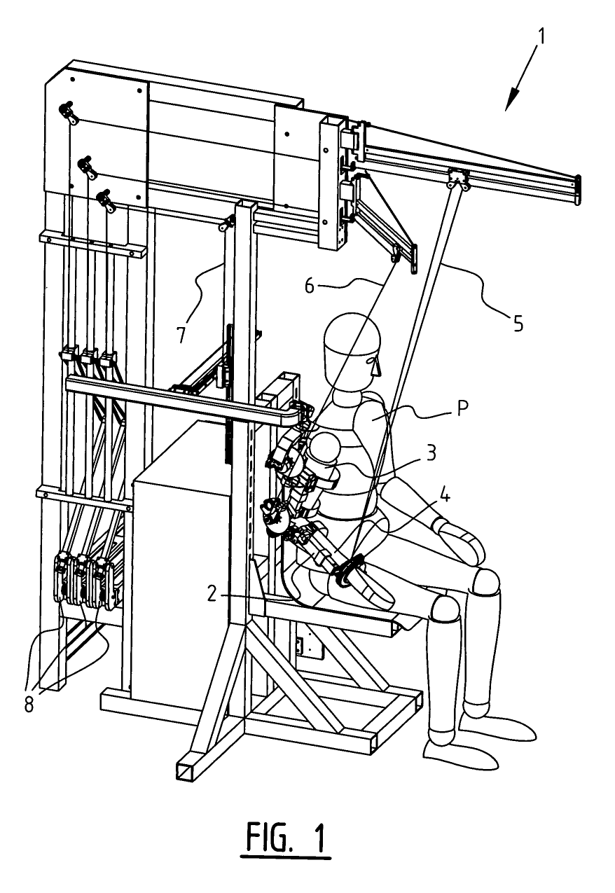

FIG. 1 shows a perspective view of a training device in which the orthesis according to the invention is used.

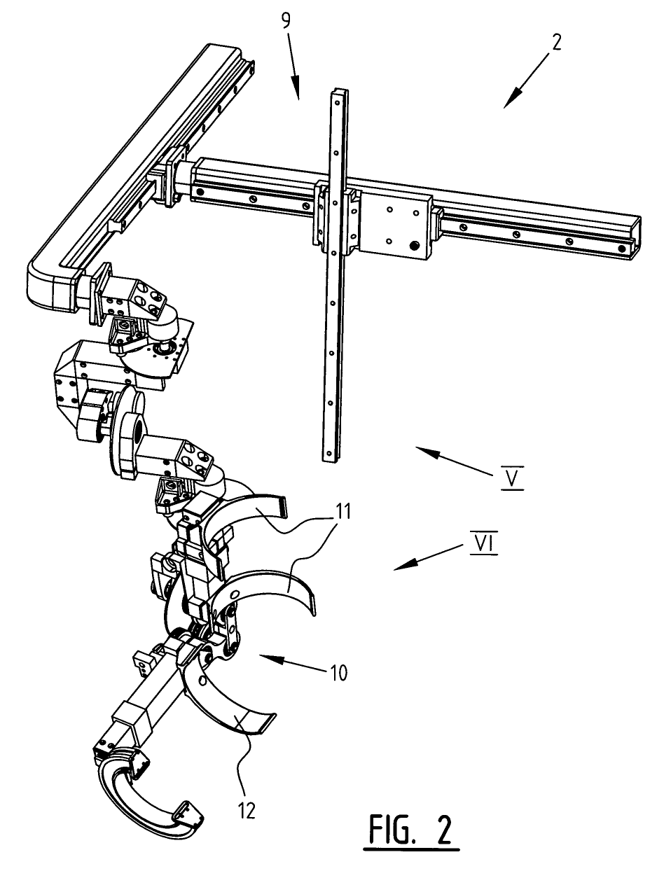

FIG. 2 shows in perspective view the orthesis used in the device according to FIG. 1.

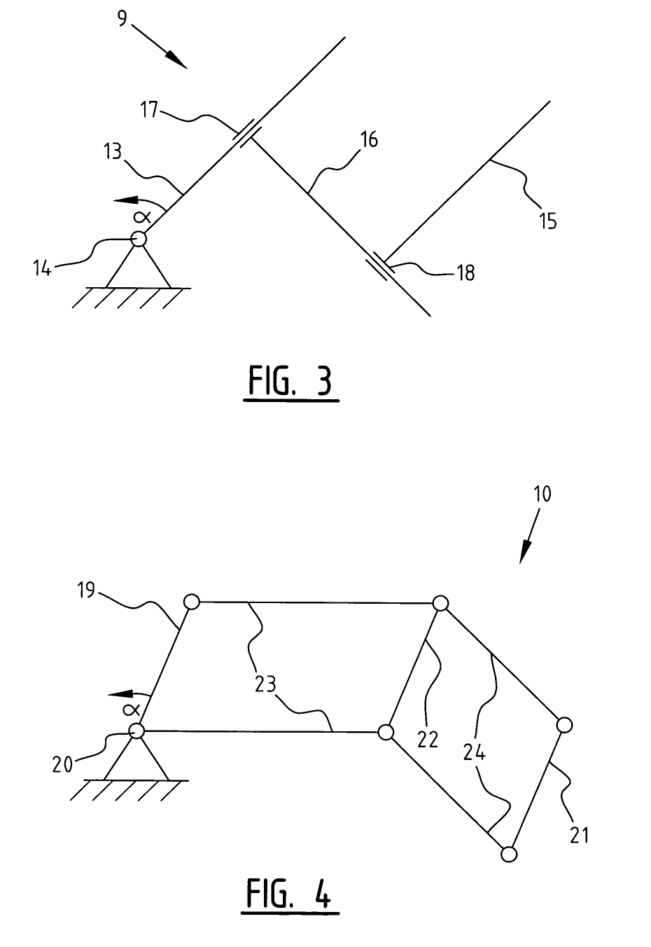

FIGS. 3 and 4 show two schematic embodiments of guide means 10 of the orthesis shown in FIG. 2.

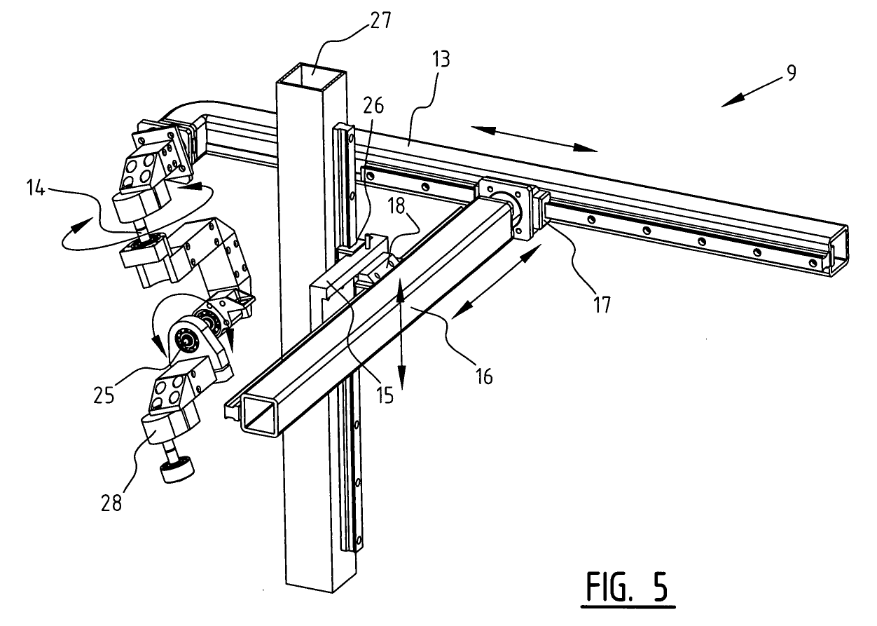

FIG. 5 shows in perspective view a first part of the orthesis.

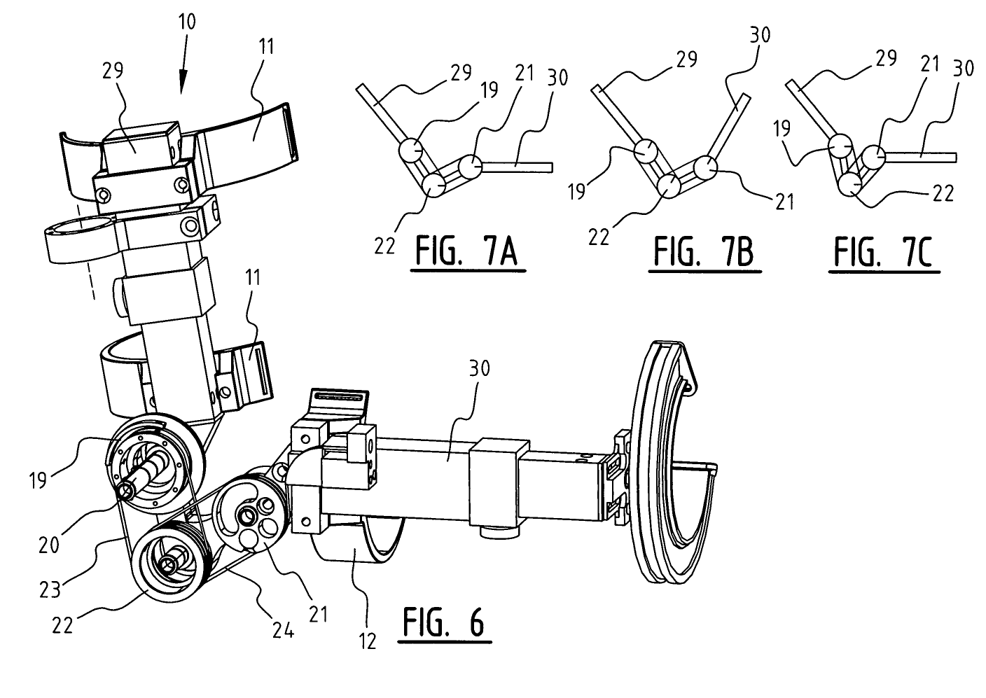

FIG. 6 shows in perspective view a second part of the orthesis.

FIGS. 7A-7C show in schematic view the functioning of the second part shown in FIG. 6.

FIG. 1 shows in perspective view a training device 1 comprising an orthesis 2 according to the invention. This orthesis 2 is strapped around the upper arm 3 and the fore arm 4 of a person P.

The orthesis 2 is kept floating by suspension to cables 5, 6, 7. These cables 5, 6, 7 are connected to adjustable spring devices 8, which compensate the weight of the orthesis 2.

FIG. 2 shows in perspective view the orthesis 2 according to the invention. This orthesis 2 comprises two guide means 9, 10 which compensate for misalignment of the shoulder and elbow respectively. Straps 11, 12 are arranged to attach the orthesis 2 to the upper arm 3 and 4 arm 4.

FIG. 3 shows a schematic view of the guide means 9. A first arm 13 is rotatably arranged at a rotation point 14. A second arm 15 is kept parallel by connection rod 16. The connection rod 16 is slidably arranged at the first arm 13 by a slide 17 and the second arm 15 is slidably arranged to the connecting rod 16 by a slide 18. When the first arm 13 is rotated around the rotation point 14 over an angle alpha, the second arm 15 will also rotate over this angle as both arms 13, 15 are kept parallel. As the slide 17 and 18 are perpendicular the second arm 15 can move freely in two dimensions.

FIG. 4 shows a schematic view of the guide means 10. A first arm 19 is rotatably arranged at a rotation point 20. A second arm 21 is kept parallel to the first arm 19 by a rod system. This rod system comprises a first rod 22, which is parallel to the first arm 19 and second arm 21. A first pair of rods 23 is rotatably connected between the first arm 19 and the first rod 22. A second pair of parallel rods 2 is rotatably arranged between the first rod 22 and the second arm 21. Due to the arrangement of the first rod 22, first pair of rods 23 and second pare of rods 24 it is possible to keep both arms 19, 21 parallel while the second arm 21 is freely moveable in two dimensions.

In FIG. 5 the guide means are shown as used in the training device as shown in FIG. 1. The same reference numerals as used in FIG. 3 are used in FIG. 5. Although in FIG. 3 a two dimensional system was shown, the guide means 9 shown in FIG. 5 is in fact a three dimensional system. In order to provide the additional dimension a second point of rotation 25 and a third point of rotation 28 are provided which are mutually under an angle with respect to each other and with respect to the first point of rotation 14, these angles preferably, as shown, but not necessarily being perpendicular angles. Also in this arrangement the arm 13 and arm 15 are parallel, ie. In the same rotational disposition with respect to each other. Furthermore, a third slide 26 is provided and arranged to a vertical beam 27. Due to this arrangement it is now possible to move the attachment point 28 in three dimensions while the orientation of the rotation point 28 is not restricted by the orientation of the beam 27. By attaching the upper arm 3 to this rotation point 28 it is possible to move the upper arm freely without any restriction. However, by providing some movement of force, for instance friction at the rotation points 25, 14, 28 it is possible to influence the rotational movement of the upper arm of the person P without restricting the movement of the shoulder in three dimensions and without introducing forces on the shoulder joints.

In FIG. 6 the second guide means 10 are shown. The same reference numerals as used in FIG. 4 are used in this figure. The snares 23, 24 provide the same function as the pair of rods 23, 24 of the rod system. The reels 19, 21, 22 provide the same function as the first arm 19, first rod 22 and second 21 respectively. The beam 29, which is connected at one end to the rotation point 28, is fixedly arranged with the other end to the rotation point 20. The second beam 30 to which the fore arm 4 is placed is fixedly connected to the reel 21.

As shown in FIGS. 7A-7C the second beam 30 can be moved freely in two dimensions. The rotation of this second beam 30 and accordingly the rotation of the reel 21 is connected to the reel 19 which takes the same rotation angle. Now by providing for example a brake between the reel 19 and first beam 29 it is possible to provide friction to the rotational movement of the second beam 30, while free movement in two dimensions of the second beam 30 is maintained.

1. An orthesis for controlling the angle of a limb relative to a second body part to which limb is connected via a joint which orthesis comprises:
a. a first arm rotatably, around a rotation point, connected to the second body part;
b. a second arm fixedly arranged to the limb; and
c. guide means for providing at least a two dimensional free translation of the second arm relative to the first arm, while maintaining both arms parallel.

2. The orthesis according to claim 1, wherein the guide means comprise a rod system comprising:
a. a first rod parallel to both arms;
b. a first pair of parallel equal length rods, each rotatably connecting the first rod with the first arm; and
c. a second pair of parallel equal length rods, each rotatably connecting the first rod with the second arm.

3. The orthesis according to claim 1, wherein the guide means comprise a rod system comprising a connecting rod, which is with one end slidably arranged to the first arm and with the other end slidably arranged to the second arm, wherein the two sliding directions are perpendicular to each other.

4. The orthesis according to claim 1, further comprising control means for controlling the rotation of the first arm.

5. The orthesis according to claim 4, wherein the control means comprise friction means for providing friction to the rotation point.

6. The orthesis according to claim 4, wherein the control means comprise a motor for propelling the first arm.

7. The orthesis according to claim 1, wherein the rotation point of the first arm comprises a strap for attachment to a body part.

8. The orthesis according claim 1, wherein the second arm comprises a strap for attachment to the limb.

9. The orthesis according to claim 5, wherein the control means comprise a motor for propelling the first arm.
